(19) United States
(12) Patent Application Publication
(10) Pub. No.: US 2025/0369542 A1
(43) Pub. Date: Dec. 4, 2025

(54) SYSTEMS, DEVICES, AND METHODS FOR ENHANCING DISTRIBUTION OF FASTENER FORCE FOR CONNECTION OF FLANGED PIPES

(71) Applicant: Marathon Petroleum Company LP, Findlay, OH (US)

(72) Inventor: Jordan Austin Scott Burress, Findlay, OH (US)

(73) Assignee: Marathon Petroleum Company LP, Findlay, OH (US)

(21) Appl. No.: 19/222,805

(22) Filed: May 29, 2025

Related U.S. Application Data
(60) Provisional application No. 63/654,160, filed on May 31, 2024.

(51) Int. Cl. F16L 23/00; F16B 31/02

(52) U.S. Cl. CPC F16L 23/003; F16B 31/028

(57) ABSTRACT

A visual guide and related methods to enhance distribution of fastener force for connections associated with flanged pipes may include an overlay. The overlay may be configured to be connected to an outward facing surface of a first flanged pipe, and the overlay may include indicators spaced from one another. The indicators may include sequence markers indicative of (a) circumferential fastener locations corresponding to fasteners for securing a first flange of the first flanged pipe to a second flange of a second flanged pipe or a pipe blank, and (b) a tightening sequence indicative of an order for tightening the fasteners. The indicators may be positioned to provide a guide for the tightening sequence, thereby to enhance the distribution of fastener force around the first flange for the fasteners securing the first flanged pipe to the second flanged pipe or the pipe blank.

### CROSS-REFERENCE TO RELATED APPLICATIONS

This application claims priority to and the benefit of U.S. Provisional Patent Application No. 63/654,160, filed May 31, 2024, which is incorporated by reference in its entirety.

### TECHNICAL FIELD

The present disclosure relates to systems, devices, and methods for enhancing distribution of fastener force and, more particularly, to systems, devices, and methods for enhancing distribution of fastener force associated with connection of flanged pipes.

### BACKGROUND

When assembling pipes, for example, for constructing a pipeline, one or more technicians may connect pipe sections to one another in an end-to-end manner via respective pipe flanges. Many such connections may include a relatively large number of fasteners for connecting the flanges of adjacent pipes to one another. For many such connections, it may be important to evenly distribute the fastener tightening force around the circumference of the flanges holding the pipe sections to one another, for example, to prevent leakage from the connection or unintended separation of the connection. Obtaining an even distribution of force may necessitate adhering to a relatively complex procedure for achieving even distribution of the tightening force. In addition, as the number of fasteners holding the flanges together increases, the procedure may become even more complex and critical. For example, the fasteners may be tightened in a certain pattern and sequence, sometimes to predetermined torque specifications. In some instances, it may be necessary to tighten certain fasteners to a first torque specification and in a predetermined sequence, followed by, once again, tightening the same and/or other fasteners to another torque specification and in another predetermined sequence. Applicant has recognized that this relatively complex tightening procedure may be difficult for technicians to accurately follow when connecting adjacent pipe sections in the field. For example, in order to follow such a procedure, a technician may need to consult a guide book providing the sequence and/or torque specifications. Applicant has recognized that this may often be tedious, inefficient, and error-prone, especially outdoors and in challenging environmental conditions.

Accordingly, Applicant has recognized a need for enhancing distribution of fastener force associated with connection of flanged pipes that may result in relatively more consistent, relatively more efficient, and/or relatively more reliable connection of pipe sections. The present disclosure may address one or more of the above-referenced considerations, as well as other possible considerations.

### SUMMARY

As referenced above, Applicant has recognized that it may be difficult and/or inefficient to connect pipe sections to one another, for example, when assembling a pipeline. Tightening the fasteners for connecting the pipe sections together may be tedious, inefficient, and error-prone, especially outdoors and in challenging environmental conditions.

The present disclosure generally is directed to systems, devices, and methods for enhancing distribution of fastener force associated with connection of flanged pipes that may result in relatively more consistent, relatively more efficient, and/or relatively more reliable connection of pipe sections that may address one or more of the above- mentioned considerations, as well as possibly others. For example, in some embodiments, systems, devices, and methods for enhancing distribution of fastener force for connections associated with flanged pipes may provide a visual guide to assist a technician when connecting pipe sections to one another and/or making other connections associated with flanged pipes.

In some embodiments, a visual guide to enhance distribution of fastener force for connections associated with flanged pipes may include an overlay having indicators spaced from one another. The indicators may be positioned to face outward when the overlay is connected to an outward facing surface of a first flanged pipe. The indicators may include sequence markers indicative of circumferential fastener locations corresponding to fasteners for securing the first flange of the first flanged pipe to one of: (a) a second flange of a second flanged pipe or (b) a pipe blank positioned to cap the first flanged pipe. The sequence markers further may be indicative of a tightening sequence indicative of an order for tightening the fasteners. The indicators may be positioned to provide a guide for the tightening sequence, thereby to enhance the distribution of fastener force around the first flange for the fasteners securing the first flanged pipe and the one of the second flange or the pipe blank.

In some embodiments, a visual guide to enhance distribution of fastener force for connection of flanged pipes may include an elongated strip of material. The elongated strip of material may be flexible, thereby to be wrapped around a radially outward facing surface of a first flanged pipe. The elongated strip of material may include indicators spaced along a length of the elongated strip of material, the indicators being positioned to face radially outward when the elongated strip of material is connected to the first flanged pipe. The indicators may include sequence markers indicative of circumferential fastener locations corresponding to fasteners for securing a first flange of the first flanged pipe to a second flange of a second flanged pipe. The indicators further may be indicative of a tightening sequence indicative of an order for tightening the fasteners. The indicators may be positioned to provide a guide for the tightening sequence, thereby to enhance the distribution of fastener force around the first flange for the fasteners securing the first flanged pipe and the second flanged pipe to one another.

In some embodiments, a visual guide to enhance distribution of fastener force for connections associated with flanged pipes may include a sheet of material at least partially defining a hole. The sheet of material may include indicators spaced around a periphery of the sheet of material. The indicators may be positioned to face axially outward when the sheet of material is connected to a first flanged pipe. The indicators may include sequence markers indicative of circumferential fastener locations corresponding to fasteners for securing a first flange of the first flanged pipe to one of (i) a second flange of a second flanged pipe or (ii) a pipe blank positioned to cap the first flanged pipe. The sequence markers further may be indicative of a tightening sequence indicative of an order for tightening the fasteners. The indicators may be positioned to provide a guide for the tightening sequence, thereby to enhance the distribution of fastener force around the first flange for the fasteners securing the first flanged pipe and the one of the second flange or the pipe blank.

In some embodiments, a visual guide set to enhance distribution of fastener force for connection of flanged pipes having one or more of different sizes or different pressure ratings may include a plurality of different visual guides according to any of the visual guides disclosed herein. The plurality of different visual guides may include a first visual guide of the plurality of visual guides. The first visual guide may include a first overlay including first indicators spaced apart from one another. The first indicators may be positioned to face outward when the first overlay is connected to one or more of: (a) a first flanged pipe, or (b) a second flanged pipe. The first flanged pipe and the second flanged pipe may each have a first size and a first pressure rating. The visual guide set further may include a second visual guide of the plurality of visual guides. The second visual guide may include a second overlay including second indicators spaced apart from one another. The second indicators may be positioned to face outward when the second overlay is connected to one or more of: (a) a third flanged pipe, or (b) a fourth flanged pipe. The third flanged pipe and the fourth flanged pipe may each have a second size and a second pressure rating.

In some embodiments, a method for enhancing distribution of fastener force for connections associated with flanged pipes may include positioning a first flange of a first flanged pipe adjacent to one of: (i) a second flange of a second flanged pipe or (ii) a pipe blank positioned to cap the first flanged pipe. The first flange and the one of the second flange of the second flanged pipe or the pipe blank may include a plurality of holes for connecting the first flange of the first flanged pipe to the one of the second flange of the second flanged pipe or the pipe blank. The method further may include connecting a visual guide to one of the first flanged pipe, the second flanged pipe, or the pipe blank. The method also may include orienting the visual guide relative to the one of the first flanged pipe, the second flanged pipe, or the pipe blank, such that indicators spaced from one another on the visual guide are substantially circumferentially aligned with the plurality of holes. The method further may include associating fasteners with the plurality of holes and tightening the fasteners according to the indicators on the visual guide, the indicators including sequence markers indicative of a sequence for tightening the fasteners, thereby to enhance distribution of fastener force around the first flange.

In some embodiments, a method for enhancing connection of a first flanged pipe and a second flanged pipe to one another may include positioning a first flange of the first flanged pipe adjacent a second flange of the second flanged pipe, one or more of the first flange or the second flange including a plurality of holes for connecting the first flanged pipe and the second flanged pipe to one another. The method further may include wrapping a visual guide circumferentially around the first flanged pipe, the visual guide including an elongated strip of material. The method also may include orienting the visual guide relative to the first flange, such that indicators spaced along a length of the elongated strip of material are substantially circumferentially aligned with the plurality of holes. The method further may include associating fasteners with the plurality of holes and tightening the fasteners according to the indicators spaced along the length of the elongated strip of material, the indicators including sequence markers indicative of a sequence for tightening the fasteners, thereby to enhance distribution of fastener force around the first flange.

In some embodiments, a method for enhancing distribution of fastener force for connections associated with flanged pipes, may include positioning a first flange of a first flanged pipe adjacent to one of: (i) a second flange of a second flanged pipe or (ii) a pipe blank positioned to cap the first flanged pipe. The first flange and the one of the second flange of the second flanged pipe or the pipe blank may include a plurality of holes for connecting the first flange of the first flanged pipe to the one of the second flange of the second flanged pipe or the pipe blank. The method further may include connecting a visual guide to one of the first flanged pipe, the second flanged pipe, or the pipe blank. The visual guide may include a sheet of material having indicators spaced around a periphery of the sheet of material, the indicators being positioned to face axially outward when the sheet of material is connected to the one of the first flanged pipe, the second flanged pipe, or the pipe blank. The method also may include orienting the visual guide relative to the one of the first flanged pipe, the second flanged pipe, or the pipe blank, such that the indicators are substantially circumferentially aligned with the plurality of holes. The method further may include associating fasteners with the plurality of holes and tightening the fasteners according to the indicators on the visual guide, the indicators including sequence markers indicative of a sequence for tightening the fasteners, thereby to enhance distribution of fastener force around the first flange.

Still other aspects and advantages of these exemplary embodiments and other embodiments are discussed in detail herein. Moreover, it is to be understood that both the foregoing information and the following detailed description merely provide illustrative examples of various aspects and embodiments, and are intended to provide an overview or framework for understanding the nature and character of the claimed aspects and embodiments. Accordingly, these and other objects, along with advantages and features of the present disclosure, will become apparent through reference to the following description and the accompanying drawings. Furthermore, it is to be understood that the features of the various embodiments described herein are not mutually exclusive and may exist in various combinations and permutations.

### BRIEF DESCRIPTION OF THE DRAWINGS

The accompanying drawings, which are included to provide a further understanding of the embodiments of the present disclosure, are incorporated in and constitute a part of this specification, illustrate embodiments of the present disclosure, and together with the detailed description, serve to explain principles of the embodiments discussed herein. No attempt is made to show structural details of this disclosure in more detail than can be necessary for a fundamental understanding of the embodiments discussed herein and the various ways in which they can be practiced. According to common practice, the various features of the drawings discussed below are not necessarily drawn to scale. Dimensions of various features and elements in the drawings may be expanded or reduced to more clearly illustrate embodiments of the disclosure.

FIG. 1 is a schematic perspective view of an example first pipe connected to an example second pipe, and an example visual guide to enhance distribution of fastener force for connection of flanged pipes, according to embodiments of the disclosure.

FIG. 2 is a schematic partial side view and end view of an example flanged pipe, according to embodiments of the disclosure.

FIG. 3 is a schematic partial side view of an example first flanged pipe connected to an example second flanged pipe, and an example visual guide to enhance distribution of fastener force for connection of flanged pipes, according to embodiments of the disclosure.

FIG. 4 is a schematic end view showing an example tightening sequence for fasteners connecting an example flange of a first flanged pipe to a flange of a second flanged pipe, including an example visual guide to enhance distribution of fastener force for connection of the flanged pipes, according to embodiments of the disclosure.

FIG. 5 is a schematic front view and side view of an example visual guide to enhance distribution of fastener force for connection of the flanged pipes, according to embodiments of the disclosure.

FIG. 6A is a partial schematic side view of an example visual guide having example connectors for connecting a first end of the visual guide to a second end of the visual guide, according to embodiments of the disclosure.

FIG. 6B is a partial schematic side view of an example visual guide having example connectors for connecting a first end of the visual guide to a second end of the visual guide, according to embodiments of the disclosure.

FIG. 7 is a partial schematic side view of an example visual guide to enhance distribution of fastener force for connection of flanged pipes, including example tags, according to embodiments of the disclosure.

FIG. 8A is a schematic front view of another example visual guide to enhance distribution of fastener force for connections associated with flanged pipes, according to embodiments of the disclosure.

FIG. 8B is a schematic partial section end view of an example first flanged pipe connected to an example second flanged pipe, and an example visual guide consistent with the example visual guide shown in FIG. 8A, according to embodiments of the disclosure.

FIG. 8C is a schematic end view of an example pipe blank connected to an example pipe, and an example visual guide consistent with the example visual guide shown in FIG. 8A, according to embodiments of the disclosure.

FIG. 9 is a schematic front view of an example visual guide set, including a plurality of example visual guides, to enhance distribution of fastener force for connection of flanged pipes having different sizes and/or different pressure ratings, according to embodiments of the disclosure.

### DETAILED DESCRIPTION

The drawings include like numerals to indicate like parts throughout the several views, the following description is provided as an enabling teaching of exemplary embodiments, and those skilled in the relevant art will recognize that many changes may be made to the embodiments described. It also will be apparent that some of the desired benefits of the embodiments described may be obtained by selecting some of the features of the embodiments without utilizing other features. Accordingly, those skilled in the art will recognize that many modifications and adaptations to the embodiments described are possible and may even be desirable in certain circumstances. Thus, the following description is provided as illustrative of the principles of the embodiments and not in limitation thereof.

The phraseology and terminology used herein is for the purpose of description and should not be regarded as limiting. As used herein, the term “plurality” refers to two or more items or components. The terms “comprising,” “including,” “carrying,” “having,” “containing,” and “involving,” whether in the written description or the claims and the like, are open-ended terms, in particular, to mean “including but not limited to,” unless otherwise stated. Thus, the use of such terms is meant to encompass the items listed thereafter and equivalents thereof, as well as additional items. The transitional phrases “consisting of” and “consisting essentially of,” if present, are closed or semi-closed transitional phrases, respectively, with respect to any claims. Use of ordinal terms such as “first,” “second,” “third,” and the like in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish claim elements.

The present disclosure generally is directed to systems, devices, and methods for enhancing distribution of fastener force associated with connection of flanged pipes and related components that may result in relatively more consistent, relatively more efficient, and/or relatively more reliable connection of pipe sections that may address one or more of the above-mentioned considerations, as well as possibly others. For example, in some embodiments, systems, devices, and methods for enhancing distribution of fastener force associated with connection of flanged pipes may assist a technician when connecting adjacent pipes and/or related components via respective pipe flanges, for example, by providing guidance for fastener tightening sequences and/or fastener torque specifications.

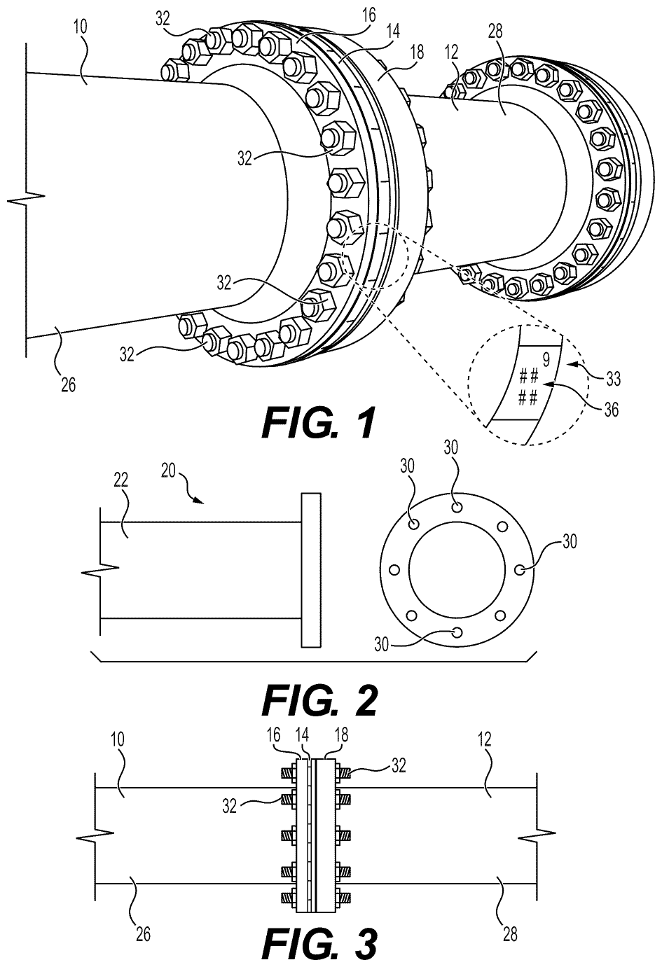

FIG. 1 is a schematic perspective view of an example first pipe 10 connected to an example second pipe 12, and an example visual guide 14 to enhance distribution of fastener force for connection of flanged pipes, according to embodiments of the disclosure. For example, FIG. 1 shows an example of a connection between the first pipe 10 and a second pipe 12. The first pipe 10 may include a flange 16, and the second pipe 12 may include a flange 18, and the flanges 16 and 18 may facilitate connection of the first pipe 10 and the second pipe 12 to one another. For example, FIG. 2 is a schematic partial side view and end view of an example pipe 20, according to embodiments of the disclosure, and the example pipe 20 includes a tubular portion 22 and a flange 24 for connecting the pipe 20 to another pipe having a similar flange. In some embodiments, each of the first pipe 10 and the second pipe 12 may include two flanges 16 and two flanges 18, respectively, at opposite ends of respective tubular portions 26 and 28 (see, e.g., FIGS. 1 and 3). As schematically shown in FIG. 2, the flange 24 may include a plurality of holes 30, and similarly, each of the flanges 16 and each of the flanges 18 shown in FIGS. 1 and 3 may include a plurality of holes.

FIG. 3 is a schematic partial side view of an example first pipe 10 connected to an example second pipe 12, according to embodiments of the disclosure. As schematically shown in FIG. 3, a plurality of fasteners 32 may be received in the holes of adjacent flanges 16 and 18 of respective adjacent pipes 10 and 12, and the fasteners 32 may secure the pipes 10 and 12 to one another, for example, as also shown in FIG. 1. In some embodiments, the fasteners 32 may include nut and bolt combinations, such as a stud threaded on opposite ends, which each receive a nut to secure the flanges 16 and 18 together. Other types of fasteners are contemplated. In some instances, a seal-improving structure, such as a gasket to improve the seal between the flanges 16 and 18, may be provided, and the flanges 16 and 18 may sandwich the seal-improving structure when the fasteners 32 are tightened.

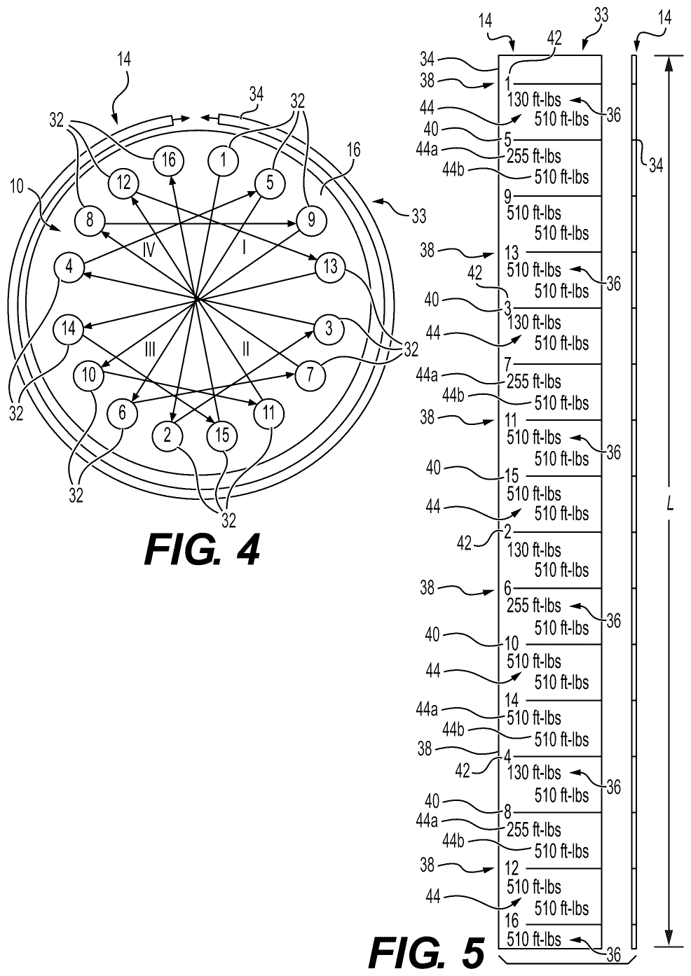

FIG. 4 is a schematic end view showing an example tightening sequence for fasteners 32 connecting an example flange 16 of a first pipe 10 to a second pipe 12, including an example visual guide 14 to enhance distribution of fastener force for connection of the pipes 10 and 12 to one another (see, e.g., FIG. 1), according to embodiments of the disclosure. FIG. 5 is a schematic front view and side view of an example visual guide 14 to enhance distribution of fastener force for connection of the pipes 10 and 12 to one another, according to embodiments of the disclosure. In at least some embodiments of the visual guide 14, the visual guide 14 may facilitate enhancing the distribution of fastener force for connection of flanged pipes. For example, in some embodiments, the visual guide 14 may facilitate relatively more consistent, relatively more efficient, and/or relatively more reliable connection of pipes and/or other related structures to one another. For example, some embodiments of the visual guide 14 may assist a technician when connecting adjacent pipes via respective pipe flanges, for example, by providing guidance for fastener tightening sequences and/or fastener torque specifications.

In some embodiments, for example, as shown in FIG. 4, the visual guide 14 may include an overlay 33 including indicators spaced from one another and being positioned to face outward when the overlay 33 is connected to an outward facing surface of a pipe 10. For example, in some embodiments, the overlay 33 may include an elongated strip of material 34 that may be wrapped circumferentially around and secured to the radially outward facing surface of the pipe 10, for example, the radially outward facing surface of the flange 16 of the pipe 10, for example, as shown in FIG. 4, and/or the radially outward facing surface of the tubular portion 26 (see, e.g., FIGS. 1 and 3) of the pipe 10. For example, as shown in FIGS. 4 and 5, in some embodiments, the visual guide 14 may include an elongated strip of material 34, and the elongated strip of material 34 may be flexible, thereby to be wrapped around a radially outward facing surface of a first pipe 10 or the second pipe 12, for example, around a first flange 16 of the radially outward facing surface of the first pipe 10 (see also FIGS. 1 and 3). As shown in FIG. 5, for example, in some embodiments, the visual guide 14 may include indicators 36 (represented by hashtags in FIG. 1), for example, visual indicators, spaced along a length L (FIG. 5) of the elongated strip of material 34. For example, the indicators 36 may be positioned along the length Z of the elongated strip of material 34 to face radially outward when the elongated strip of material 34 is connected to the first flange 16 of the first pipe 10 (and/or the second flange 18 of the second pipe 12). In some embodiments, for example, as shown in FIG. 5, the indicators 36 may include sequence markers 38 indicative of (a) circumferential fastener locations 40 corresponding to the fasteners 32 for securing the first flange 16 of the first pipe 10 to the second flange 18 of the second pipe 12 and (b) a tightening sequence 42 indicative of an order for tightening the fasteners 32. In some embodiments, the indicators 36 may be positioned to provide a guide for the tightening sequence, thereby to enhance the distribution of fastener force around the first flange 16 for the fasteners 32 securing the first pipe 10 and the second pipe 12 to one another. In at least some embodiments, the visual guide 14 may provide a visual guide for one or more technicians when tightening the fasteners 32 for connecting the two pipe flanges 16 and 18 of the adjacent pipes 10 and 12 to one another. In some embodiments, the tightening sequences may be consistent with, or comply with, guidelines set forth by regulatory bodies and/or standard-setting bodies, such as, for example, the American National Standards Institute (ANSI).

In some embodiments, for example, as shown in FIG. 5, the visual guide 14 may include indicators 36, for example, visual indicators, that further include tightening torque markers 44 associated with at least some of the sequence markers 38, for example, with each of the sequence markers 38. In some embodiments, the tightening torque markers 44 may be indicative of a respective magnitude of tightening torque to which a corresponding one of the fasteners 32 is to be tightened. For example, as shown in FIG. 5, the tightening torque markers 44 may include: (a) a first set of tightening torque markers 44a indicative of a respective first magnitude of tightening torque to which a first set of corresponding fasteners 32 is to be tightened, and (b) a second set of tightening torque markers 44b indicative of a respective second magnitude of tightening torque to which a second set of corresponding fasteners 32 is to be tightened. For example, each of the second set of tightening torque markers 44b may be indicative of a respective second magnitude of tightening torque to which the second set of corresponding fasteners 32 is to be tightened that is greater than each of the first set of tightening torque markers 44a, which are indicative of the respective first magnitude of tightening torque to which the first set of corresponding fasteners 32 is to be tightened.

In some embodiments, the sequence markers 38 may include a sequence of numbers and/or a sequence of letters, and the sequence of numbers and/or the sequence of letters may be positioned along the length L (e.g., spaced along the length L) of the elongated strip of material 34, for example, such that when the elongated strip of material 34 is wrapped around the first pipe 10 and/or the second pipe 12 (e.g., around the first flange 16 and/or the second flange 18), the sequence of numbers and/or the sequence of letters may be arranged in a non-consecutive manner, for example, as shown. For example, the sequence of numbers and/or the sequence of letters may be positioned along the length L of the elongated strip of material 34, such that when the elongated strip of material 34 is wrapped around the first flange 16 and/or the second flange 18, the sequence of numbers and/or the sequence of letters are arranged, so that: (a) consecutive numbers of the sequence of numbers and/or (b) consecutive letters of the sequence of letters is/are substantially diametrically across from one another relative to the one or more of the first flange 16 and/or the second flange 18.

In some embodiments, the tightening torque markers 44 may further include a third set of tightening torque markers indicative of a respective third magnitude of tightening torque to which a third set of corresponding fasteners 32 is to be tightened. The respective third magnitude of tightening torque to which the third set of corresponding fasteners 32 is to be tightened may be greater than: (a) the respective first magnitude of tightening torque to which the first set of corresponding fasteners 32 is to be tightened, and/or (b) the respective second magnitude of tightening torque to which the second set of corresponding fasteners 32 is to be tightened. In some embodiments, the fasteners of different sets of fasteners may be unique to an associated set of fasteners, and in some embodiments, the fasteners of the different sets of fasteners may include fasteners that are also associated with one or more other sets of fasteners.

For example, FIG. 4 and the table below provide an example tightening sequence for connecting the flanges of two 150 Class, 16-inch pipes. As shown, during a first tightening pass 1A, the fasteners 32 at positions 1, 2, 3, and 4 are tightened in sequence to a first tightening torque magnitude of 130 ft.-lbs., according to the order specified by the visual guide 14. Thereafter, during a subsequent tightening pass 1B, the fasteners 32 at positions 5, 6, 7, and 8 are tightened in sequence to a second tightening torque magnitude of 255 ft.-lbs., according to the order specified by the visual guide 14. Thereafter, during a subsequent tightening pass 1C, the fasteners 32 at positions 9, 10, 11, 12, 13, 14, 15, and 16 are tightened to a third tightening torque magnitude of 510 ft.-lbs., according to the order specified by the visual guide 14. Thereafter, during a subsequent tightening pass 2, each of the fasteners 32 is tightened to a tightening torque magnitude of 510 ft.-lbs. in the sequence shown (e.g., 1-16 consecutively). Finally, during a subsequent tightening pass 3, all the fasteners 32 are tightened to a tightening torque magnitude of 510 ft.-lbs. in a circular (clockwise) sequence (e.g., 1, 5, 9, 13, 3, 7, 11, 15, 2, 6, 10, 14, 4, 8, 12, and 16, as shown in FIG. 4). Other tightening passes, tightening sequences, and/or tightening torque magnitudes are contemplated. In this example manner, the two pipes may be connected at the respective flanges, such that the fastener tightening force around the circumference of the flanges is distributed as desired (e.g., substantially evenly distributed), providing a reliable and secure connection between the two pipes, and/or between a pipe flange and a pipe blank, for example, as described herein. In some embodiments, the indicators 36, including one or more of the sequence markers 38, the fastener locations 40, the tightening sequences 42, and/or the tightening torque markers 44, may be color-coded, for example, with the indicators 36 associated with each tightening pass having a unique color to assist technicians with the tightening procedure.

TABLE

| | | Tightening Torque |
|---|---|---|
| Tightening | Tightening Sequence | Magnitude |
| Pass | (See FIG. 4) | (Foot-Pounds) |
| 1A | 1, 2, 3, and 4 | 130 ft.-lbs. |
| 1B | 5, 6, 7, and 8 | 255 ft.-lbs. |
| 1C | 9, 10, 11, 12, 13, 14, 15, and | 510 ft.-lbs. |
| | 16 | |
| 2 | 1, 2, 3, 4, 5, 6, 7, 8, 9, 10, 11, | 510 ft.-lbs. |
| | 12, 13, 14, 15, and 16 | |
| 3 | 1, 5, 9, 13, 3, 7, 11, 15, 2, 6, | 510 ft.-lbs. |
| | 10, 14, 4, 8, 12, and 16, etc. | |
| | (e.g., in a clockwise | |
| | sequence, as shown in FIG. | |
| | 4) | |

In some embodiments, the elongated strip of material 34 may include any material or combination of materials that is/are flexible, so as to facilitate being wrapped around (a) the first pipe 10 or the second pipe 12, or (b) the first flange 16 and/or the second flange 18. For example, the elongated strip of material 34 may include, for example, a polymeric material, a magnetic material, an adhesive material, and/or an elastic material, and in some embodiments, may be configured to connect the elongated strip of material 34 to the first pipe 10 or the second pipe 12 (or the first flange 16 and/or the second flange 18 of the respective first pipe 10 and the second pipe 12). In some embodiments, the elongated strip of material 34 may include (a) a strip of magnetic material and/or a strip of adhesive material, and/or (b) a plurality of sections of magnetic material and/or a plurality of sections of adhesive material spaced along the length L of the elongated strip of material 34, such as, for example, a polymeric strip (and/or a strip of another flexible material) having magnetic material (and/or adhesive material) spaced along the length L of the elongated strip of material 34. In at least some such embodiments, the magnetic material and/or adhesive material may facilitate selective adherence (e.g., temporary adherence) of the visual guide 14 to the pipe 10 and/or the pipe 12, for example, so that the strip may be (a) connected to the pipe (or pipe flange) during installation and tightening of the fasteners 32 during assembly of adjacent pipes to one another, and (b) separated from the pipe (or pipe flange(s)) following the tightening for reuse during the installation and tightening of fasteners 32 during assembly of one or more different adjacent pipes to one another. For example, the elongated strip of material 34 may include a polymeric material (and/or similar material) connected to the strip of magnetic material and/or strip of adhesive material, or connected to the plurality of sections of magnetic material and/or sections of adhesive material. In at least some such embodiments, the indicators 36 may be on a side of the elongated strip of material 34 opposite the strip of magnetic material and/or adhesive material, or the plurality of sections of magnetic material and/or adhesive material, for example, such that the indicators face radially outward when the visual guide 14 is connected to the pipe(s) or flange(s), thereby to facilitate viewing by one or more technicians during assembly of the pipes. In some embodiments, the indicators 36 may include one or more of notches or apertures spaced along the length L of the elongated strip of material 34, for example, to provide a tactile indication of the location of the indicators 36, and/or to facilitate attachment of other structures to the elongated strip of material 34.

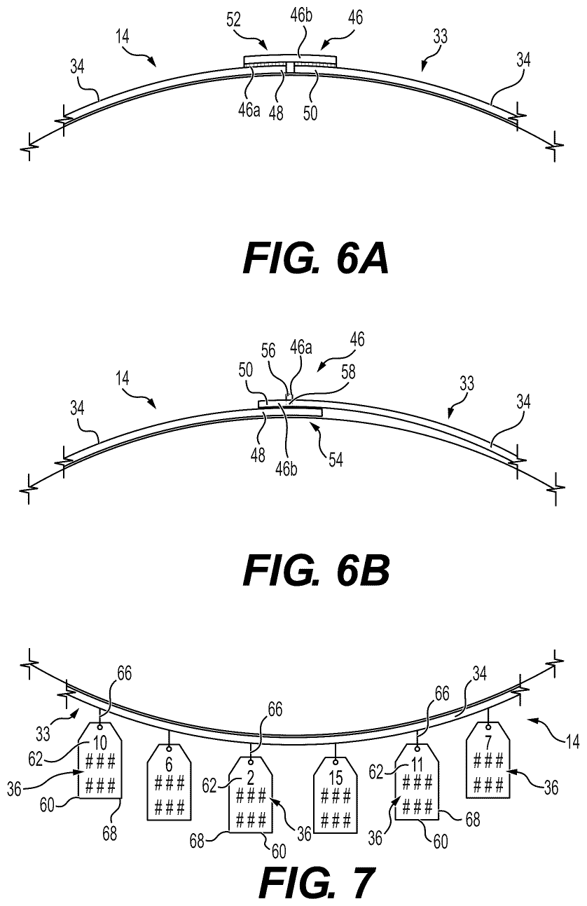

FIG. 6A is a partial schematic side view of an example visual guide 14 having example connectors 46 for connecting a first end 48 of the visual guide 14 to a second end 50 of the visual guide 14, according to embodiments of the disclosure. In some embodiments, the elongated strip of material 34 may extend from the first end 48 to the second end 50 opposite the first end 48. In at least some such embodiments, the first end 48 may include a first connector 46a, and the second end 50 may include a second connecter 46b, and the first connector 46a and the second connector 46b may be engageable with one another, such that when the elongated strip of material 34 is connected to the first pipe 10 or the second pipe 12 (or to one or more of the first flange 16 or the second flange 18), the first connector 46a and the second connector 46b secure the first end 48 and the second end 50 to one another. For example, rather than (or in addition to) including magnetic connection and/or adhesive connection to the pipe or pipe flange, the elongated strip of material 34 may be selectively connected to (e.g., temporarily connected to) the pipe or flange(s) via connection of the first end 48 and the second end 50 to one another. For example, in some embodiments, the first connector 46a and the second connector 46b may include a hook and loop fastener connector 52, for example, as schematically depicted in FIG. 6A.

FIG. 6B is a partial schematic side view of another example visual guide 14 having example connectors 46 for connecting the first end 48 of the visual guide 14 to the second end 50 of the visual guide 14, according to embodiments of the disclosure. For example, as schematically depicted in FIG. 6B, in some embodiments, the first connector 46a and the second connector 46b may include a clasp connector 54. For example, the first connecter 46a may include a pin 56, and the second connector 46b may include a receiver 58 (e.g., a hole) configured to receive the pin 56, thereby to connect the first end 48 of the visual guide 14 to the second end 50 of the visual guide 14 via engagement between the pin 56 and the receiver 58. Other forms of the connectors 46 are contemplated, such as, for example, cooperating clips at the first end 48 and the second end 50, cooperating hooks at the first end 48 and the second end 50, cooperating slots in the first end 48 and the second end 50, etc.

FIG. 7 is a partial schematic side view of an example visual guide 14 to enhance distribution of fastener force for connection of the flanged pipes, including example tags 60, according to embodiments of the disclosure. For example, as shown in FIG. 7, in some embodiments, the visual guide 14 may include a plurality of tags 60 connected to the elongated strip of material 34, and each of the plurality of tags 60 may be attached to the elongated strip of material 34 adjacent one of the plurality of indicators 36 (e.g., at the sequence markers 38) of the elongated strip of material 34. In some embodiments, the plurality of tags 60 may serve as the indicators 36 (represented by hashtags in FIG. 7), with (or without) corresponding indicators 36 being provided on the elongated strip of material 34.

In some embodiments, each of the plurality of tags 60 may include a tag sequence marker 62 corresponding to an adjacent sequence marker associated with the elongated strip of material 34 (if present), and the tag sequence markers 62 may be indicative of: (a) circumferential fastener locations corresponding to fasteners 32 for securing the first flange 16 of the first pipe 10 to the second flange 18 of the second pipe 12 (see FIG. 1) and (b) a tightening sequence indicative of an order for tightening the fasteners 32 associated with the tag sequence markers 62. In some embodiments, each of the tags 60 may further include a tag tightening torque marker 64, and the tag tightening torque markers 64 may be indicative of a respective magnitude of tightening torque to which an adjacent one of the fasteners 32 is to be tightened.

In some embodiments, each of the plurality of tags 60 may be connected to the elongated strip of material 34, such that when the elongated strip of material 34 is wrapped around the first pipe 10 or the second pipe 12 (or one or more of the first flange 16 or the second flange 18), each of the plurality of tags 60 is suspended from the elongated strip of material 34, for example, to enhance viewing of each of one or more of the plurality of tags 60 and associated indicators 36. For example, the underside of the pipe 10 and/or the pipe 12 may be relatively difficult to see without being positioned underneath the pipe 10 and/or pipe 12. Thus, it also may be relatively difficult to view the indicators 36 that are located adjacent the underside of the pipe 10 and/or pipe 12. In some embodiments, providing the tags 60 at locations corresponding to the indicators 36 that are located adjacent the underside of the pipe 10 and/or pipe 12 may render it relatively easier for a technician to view the tag sequence markers 62 and/or the tag tightening torque markers 64. In some embodiments, the plurality of tags 60 may be connected to the elongated strip of material 34 at consecutive locations associated with a subset of the sequence markers 38 of the elongated strip of material 34, for example, as schematically depicted in FIG. 7.

As shown in FIG. 7, in some embodiments, each of the plurality of tags 60 may include a hanger 66 having a proximal end connected to the elongated strip of material 34 and a distal end connected to a tab 68. Each tab 68 may include a tag sequence marker 62 corresponding to an adjacent sequence marker 38 associated with the elongated strip of material 34. In some embodiments, the hanger 66 may include a length of string or wire, and, in some embodiments, the tab 68 may include a polymer sheet including a tag sequence marker 62 and/or a tag tightening torque marker 64. In some embodiments, hangers 66 may be connected to the elongated strip of material via a hanger-to-strip connection, such as, for example, fastening (e.g., via a knot in the hanger 66 and a hole or boss in the elongated strip of material 34), welding, adhesive, rivets, etc.

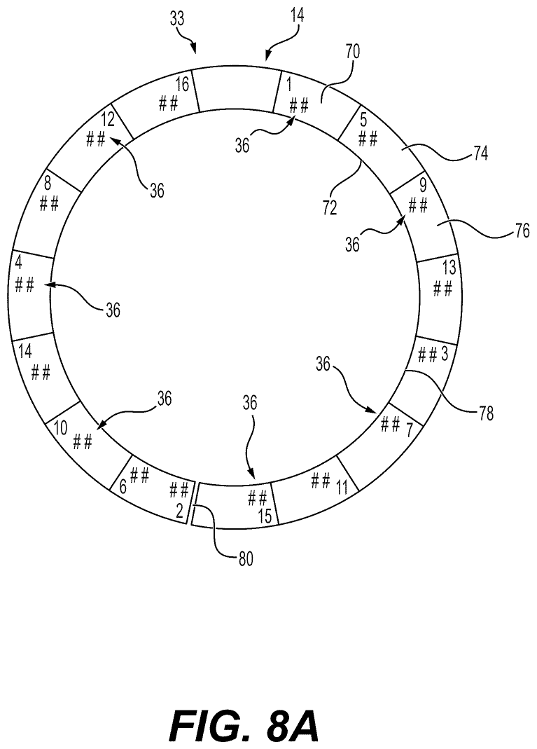

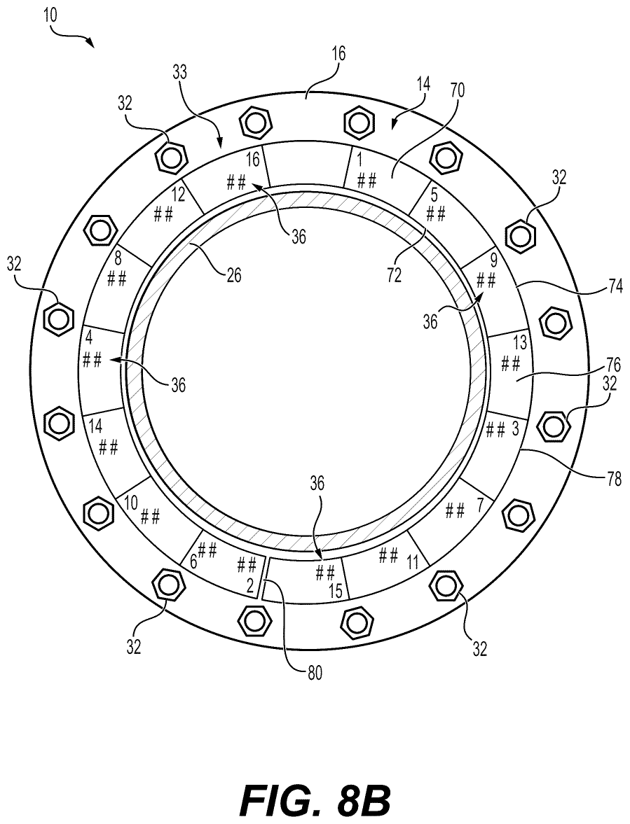

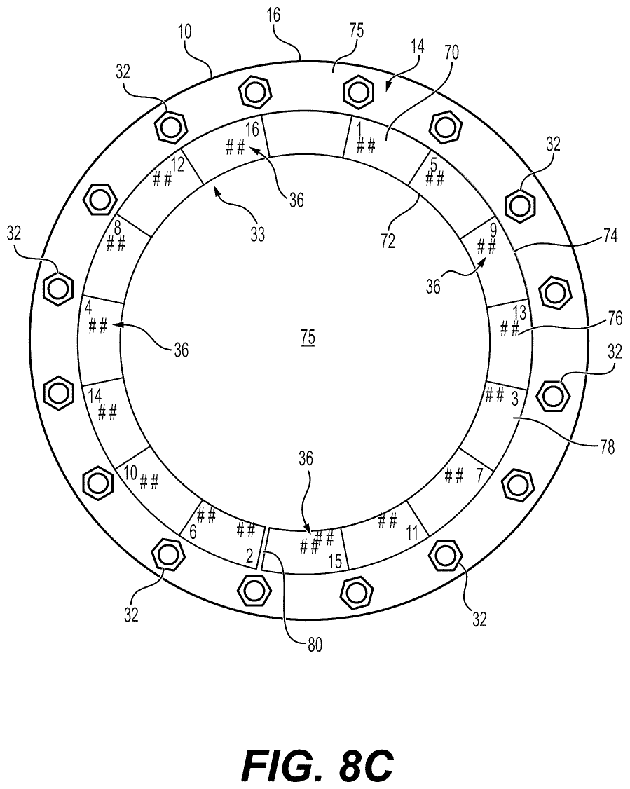

FIG. 8A is a schematic front view of another example visual guide 14 to enhance distribution of fastener force for connections associated with flanged pipes, according to embodiments of the disclosure. As shown in FIG. 8A, for example, in some embodiments, a visual guide 14 to enhance distribution of fastener force for connections associated with flanged pipes may include an overlay 33 including indicators 36 spaced from one another and being positioned to face outward when the overlay 33 is connected to an outward facing surface of a pipe 10. For example, in some embodiments, the overlay 33 may include a sheet of material 70 at least partially defining a hole 72 (e.g., a substantially circular hole). As schematically shown in FIG. 8A, the sheet of material 70 may include indicators 36 (represented by hashtags in FIG. 8A), for example, visual indicators, spaced around a periphery 74 of the sheet of material 70, and the indicators 36 may be positioned to face axially outward, for example, when the sheet of material 70 is connected to a first flange 16 of a first pipe 10. For example, in some embodiments, the indicators 36 may include sequence markers 38 indicative of circumferential fastener locations corresponding to fasteners 32 for securing the first flange 16 of the first pipe 10 to: (a) a second flange 18 of a second pipe 12 (see, e.g., FIG. 8B), or (b) a pipe blank 75 (see, e.g., FIG. 8C) positioned to cap the first pipe 10.

FIG. 8B is a schematic partial section end view of an example first pipe 10 connected to an example second pipe 12 (not shown in FIG. 8B), and the example visual guide 14 consistent with the visual guide 14 shown in FIG. 8A, according to embodiments of the disclosure. In some embodiments, the visual guide 14 may be configured to be positioned radially inside the fasteners 32 (see, e.g., FIG. 8B), and in some embodiments, the visual guide 14 may be configured to be positioned radially outside the fasteners 32. FIG. 8C is a schematic end view of an example pipe blank 75 connected to an example first pipe 10 (not viewable in FIG. 8C), and an example visual guide 14 consistent with the visual guide 14 shown in FIG. 8A, according to embodiments of the disclosure. For example, in some embodiments, the pipe blank 75 may include a plurality of holes generally corresponding to the plurality of holes 30 in the first flange 16 of the first pipe 10, and the fasteners 32 may be used to assemble the pipe blank 75 and the first flange 16 to one another, thereby to cap the opening of the first pipe 10. In at least some such embodiments, the visual guide 14 may be connected to an outward facing side of the pipe blank 75 adjacent the holes and/or fasteners, for example, as shown in FIG. 8C. In some embodiments, the visual guide 14 may be configured to be positioned radially inside the fasteners 32 (see, e.g., FIG. 8C), and in some embodiments, the visual guide 14 may be configured to be positioned radially outside the fasteners 32.

In some embodiments, the visual guides 14 consistent with the example visual guide 14 shown in FIGS. 8A-8C may be configured to facilitate connection of two adjacent pipes to one another, for example, in a manner at least similar to the manner schematically depicted in FIG. 1. For example, the visual guide 14 may be substantially circular, forming a ring 76, for example, as shown in FIGS. 8A-8C, and the ring 76 may be connected to an outward facing portion of either the first flange 16 of the first pipe 10 or the second flange 18 of the second pipe 12, for example, with either: (a) an inner circumferential edge 78 of the substantially circular hole 72 of the sheet of material 70 radially outside of the holes 30 and/or the fasteners 32 (upon insertion of the fasteners 32 into the holes 30), or (b) the periphery 74 of the sheet of material 70 (e.g., an outer circumference of the sheet of material 70) radially inside of the holes 30 and/or the fasteners 32 (upon insertion of the fasteners 32 into the holes 30), for example, as shown in FIGS. 8B and 8C.

In some embodiments, the sequence markers 38 (represented by hashtags in FIGS. 8A- 8C) further may be indicative of a tightening sequence indicative of an order for tightening the fasteners 32. For example, the indicators 36 (represented by hashtags in FIGS. 8A-8C), for example, visual indicators, may be positioned to provide a guide for the tightening sequence, thereby to enhance the distribution of fastener force around, for example, the pipe blank 75 or the first flange 16 for the fasteners 32 securing the pipe blank 75 to the first pipe 10 and/or for securing the first flange 16 of the first pipe 10 to a second flange 18 of a second pipe 12.

In at least some embodiments consistent with FIGS. 8A-8C, the sheet of material 70 may be substantially circular, and the indicators 36 may be spaced around a circumference of the sheet of material 70. As shown in FIGS. 8A-8C, in some embodiments, the sheet of material 70 may at least partially define a discontinuity 80 configured to facilitate placement of the sheet of material 70 around a tubular portion 26 (see, e.g., FIGS. 1 and 8B) of the first pipe 10 or the second pipe 12. In some embodiments, the discontinuity may include a slit in the sheet of material 70, for example, as shown. Some embodiments may not include a discontinuity.

In some embodiments, the indicators 36 further may include tightening torque markers 44 (represented by hashtags in FIGS. 8A-8C) associated with at least some of the sequence markers 38. The tightening torque markers 44 may be indicative of a respective magnitude of tightening torque to which a corresponding one of the fasteners 32 is to be tightened. In some embodiments, the tightening torque markers 44 may include a first set of tightening torque markers 44a (see, e.g., FIG. 5) indicative of a respective first magnitude of tightening torque to which a first set of corresponding fasteners 32 is to be tightened. In at least some such embodiments, the tightening torque markers 44 may further include a second set of tightening torque markers 44b (see, e.g., FIG. 5) indicative of a respective second magnitude of tightening torque to which a second set of corresponding fasteners 32 is to be tightened. In some embodiments, the respective second magnitude of tightening torque to which the second set of corresponding fasteners 32 is to be tightened may be greater than the respective first magnitude of tightening torque to which the first set of corresponding fasteners 32 is to be tightened. In some embodiments, the tightening torque markers 44 further may include a third set of tightening torque markers indicative of a respective third magnitude of tightening torque to which a third set of corresponding fasteners 32 is to be tightened. The respective third magnitude of tightening torque to which the third set of corresponding fasteners 32 is to be tightened may be greater than: (a) the respective first magnitude of tightening torque to which the first set of corresponding fasteners 32 is to be tightened, and/or (b) the respective second magnitude of tightening torque to which the second set of corresponding fasteners 32 is to be tightened, for example, as explained herein. In some embodiments, the fasteners of different sets of fasteners may be unique to an associated set of fasteners, and in some embodiments, the fasteners of the different sets of fasteners may include fasteners that are also associated with one or more other sets of fasteners.

In some embodiments, the sheet of material 70 may include any material or combination of materials that may be connected to the first flange 16 of the first pipe 10 and/or to an outer surface of the pipe blank 75. For example, the sheet of material 70 may include, for example, a polymeric material, a magnetic material, an adhesive material, and/or an elastic material, and in some embodiments, may be configured to connect the sheet of material 70 to the first pipe 10, the second pipe 12 (or the first flange 16 and/or the second flange 18 of the respective first pipe 10 and the second pipe 12), and/or to an outer surface of the pipe blank 75. In some embodiments, the sheet of material 70 may include (a) a sheet of magnetic material and/or a sheet of adhesive material, and/or (b) a plurality of sections of magnetic material and/or a plurality of sections of adhesive material spaced around the sheet of material 70, such as, for example, a polymeric sheet (and/or a sheet of another similar material) having magnetic material (and/or adhesive material) spaced around the sheet of material 70. In at least some such embodiments, the magnetic material and/or adhesive material may facilitate selective adherence (e.g., temporary adherence) of the visual guide 14 to the pipe 10, the pipe 12, and/or the pipe blank 75, for example, so that the sheet may be (a) connected to the pipe, pipe flange, and/or outer surface of the pipe blank, during installation and tightening of the fasteners 32 during assembly of adjacent pipes to one another (or a pipe blank to a pipe flange) and (b) thereafter separated from the pipe (or pipe flange(s) or pipe blank) following the tightening for reuse during the installation and tightening of fasteners 32 during assembly of one or more different adjacent pipes to one another (and/or a pipe blank to a respective pipe flange). For example, the sheet of material 70 may include a polymeric material (and/or similar material) connected to the sheet of magnetic material and/or adhesive material, or the plurality of sections of magnetic material and/or adhesive material. In at least some such embodiments, the indicators 36 may be on a side of the sheet of material 34 opposite the sheet of magnetic material and/or adhesive material, or the plurality of sections of magnetic material and/or adhesive material, for example, such that the indicators face radially outward when the visual guide 14 is connected to the pipe(s), flange(s) and/or pipe blank, thereby to facilitate viewing by one or more technicians during assembly of the pipes or the assembly of a pipe blank to a pipe flange. In some embodiments, the indicators 36 may include one or more of notches or apertures spaced around the periphery 74 the sheet of material 70, for example, to provide a tactile indication of the location of the indicators 36, and/or to facilitate attachment of other structures to the sheet of material 34.

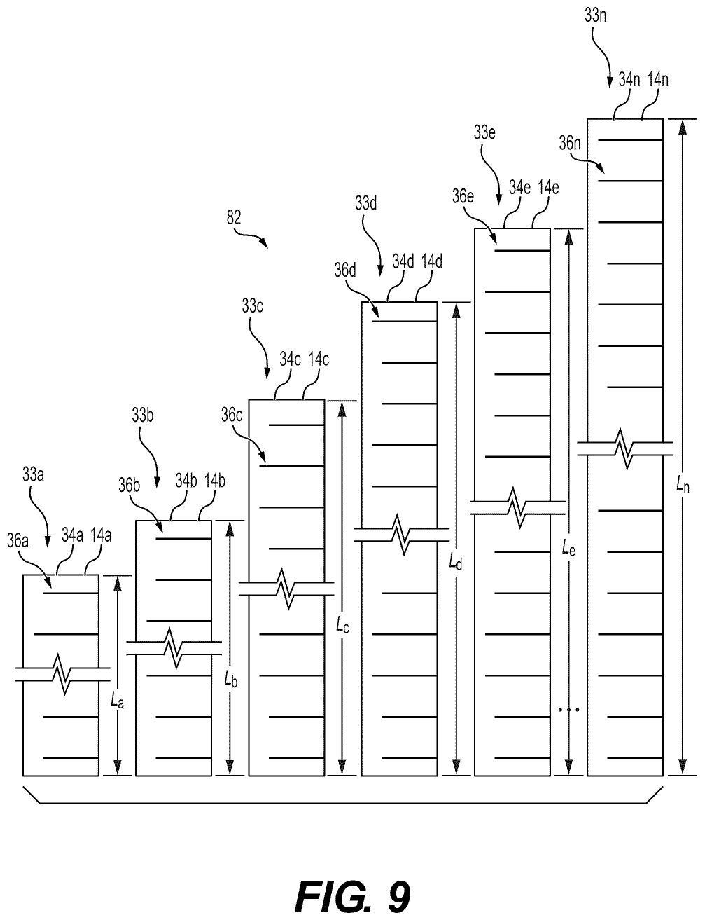

FIG. 9 is a schematic front view of an example visual guide set 82 to enhance distribution of fastener force for connection of flanged pipes having different sizes and/or different pressure ratings, according to embodiments of the disclosure. For example, the visual guide set 82 may include a plurality of different visual guides 14a through 14n, for example, according to any one or more of the visual guides 14 described herein, including those shown in FIGS. 1 and 3-8C. In some embodiments, the visual guide set 82 may include a plurality of different visual guides 14a-14n, and the visual guides 14 may include, for example, a first visual guide 14a of the plurality of visual guides 14a-14n, and the first visual guide 14a may include a first overlay 33a (e.g., a first elongated strip of material 34a or a first sheet of material) including first indicators 36a spaced apart from one another (e.g., spaced along a length La of the first elongated strip of material 34a). The first indicators 36a may be positioned to face outward (e.g., radially outward) when the first overlay 33a (e.g., the first elongated strip of material 34a or around a periphery of the first sheet of material) is connected to one or more of: (a) a first flange 16 of a first pipe 10 or (b) a second flange 18 of a second pipe 12. The first pipe 10 and the second pipe 12 may each have a first size and a first pressure rating. The visual guide set 82 further may include a second visual guide 14b of the plurality of visual guides 14a through 14n. The second visual guide 14b may include a second overlay 33b (e.g., a second elongated strip of material 34b or a second sheet of material) including second indicators 36b spaced apart from one another (e.g., spaced along a length Lb of the second elongated strip of material 34b or around a periphery of the second sheet of material). The second indicators 36b may be positioned to face outward (e.g., radially outward) when the second overlay 33b (e.g., the second elongated strip of material 34b) is connected to one or more of: (a) a third flange of a third flanged pipe, or (b) a fourth flange of a fourth flanged pipe, wherein the third flanged pipe and the fourth flanged pipe each have a second size and a second pressure rating. In some embodiments, one or more of: (a) the first size may be different than the second size, or (b) the first pressure rating may be different than the second pressure rating. For example, the visual guide set 82, in some embodiments, may include a set of different visual guides 14a-14n to facilitate connection of pipes having a different size and/or a different pressure rating, for example, a first visual guide 14a for connecting two pipes together, each having a first size and a first pressure rating, and a second visual guide 14b for connecting two pipes together, each having a second size and a second pressure rating, wherein the first size is different than the second size and/or the first pressure rating is different than the second pressure rating. In at least some such embodiments, a technician may have a visual guide set 82, and the technician, during a first pipe assembly, may select a first visual guide 14 from the visual guide set 82 that corresponds to the size and pressure rating of the pipes to be connected to one another. During another pipe assembly, for pipes having a different size and/or a different pressure rating, the technician (or another technician), may select a different visual guide 14 from the visual guide set 82 that corresponds to the different size and/or different pressure rating of the pipes to be connected to one another during the other pipe assembly. In some embodiments, a container, such as, for example, a visual guide case, may be provided to carry the visual guide set 82. In some embodiments, a kit may include, for example, a visual guide case and/or a plurality of visual guides of a visual guide set.

In some embodiments, the visual guide set 82 further may include a third visual guide 14c of the plurality of visual guides 14a through 14n, and the third visual guide 14c may include a third overlay 33c (e.g., a third elongated strip of material 34c or a third sheet of material) having third indicators 36c spaced apart from one another (e.g., spaced along a length Le of the third elongated strip of material 34c or around a periphery of the third sheet of material), with the third indicators 36c being positioned to face outward (e.g., radially outward) when the third overlay 33c (e.g., the third elongated strip of material 34c or the third sheet of material) is connected to one or more of: (a) a fifth flange of a fifth flanged pipe, or (b) a sixth flange of a sixth flanged pipe, the fifth flanged pipe and the sixth flanged pipe each having a third size and a third pressure rating. The third size may be different than the first size and the second size, and/or the third pressure rating may be different than the first pressure rating and the second pressure rating.

In some embodiments, the first indicators 36a further may include first tightening torque markers 44a (see, e.g., FIG. 5) associated with at least some of the first sequence markers 38, the first tightening torque markers 44a being indicative of a respective first magnitude of tightening torque to which a corresponding one of a plurality of first fasteners 32 is to be tightened to connect the first pipe 10 and the second pipe 12 to one another, for example, via the first flange 16 and the second flange 18. In some embodiments, the second indicators 36b further may include second tightening torque markers 44b (see, e.g., FIG. 5) associated with at least some of the second sequence markers 38, the second tightening torque markers 44b being indicative of a respective second magnitude of tightening torque to which a corresponding one of a plurality of second fasteners is to be tightened to connect the third pipe and the fourth pipe to one another, for example, via a respective third flange and a respective fourth flange. In at least some such embodiments, the respective first magnitude of tightening torque may be different than the respective second magnitude of tightening torque.

In some embodiments, a method for enhancing distribution of fastener force for connections associated with flanged pipes may include positioning a first flange of a first flanged pipe adjacent to a second flange of a second flanged pipe or a pipe blank positioned to cap the first flanged pipe. Positioning of the first flange adjacent to the second flange or the pipe blank may include moving one or more of the first flange, the second flange, or the pipe blank toward one another. The first flange and the second flange of the second flanged pipe and/or the pipe blank may each include a plurality of holes for connecting the first flange of the first flanged pipe to the second flange of the second flanged pipe or the pipe blank, for example, as described herein. The method further may include connecting a visual guide to one of the first flanged pipe, the second flanged pipe, or the pipe blank, and orienting the visual guide relative to the one of the first flanged pipe, the second flanged pipe, or the pipe blank, such that indicators spaced from one another on the visual guide are substantially circumferentially aligned with the plurality of holes. The visual guide may be consistent with any visual guides described herein, such as, for example, the example visual guides shown in FIGS. 1 and 3-9. The method also may include associating fasteners with the plurality of holes and tightening the fasteners according to the indicators on the visual guide, the indicators including sequence markers indicative of a sequence for tightening the fasteners, thereby to enhance distribution of fastener force around the first flange, for example, as described herein.

In some embodiments of the method for enhancing distribution of fastener force for connections associated with flanged pipes, the visual guide may include an elongated strip of material, and the connecting of the visual guide to one of the first flanged pipe, the second flanged pipe, or the pipe blank may include wrapping the elongated strip of material at least partially circumferentially around the one of the first flanged pipe, the second flanged pipe, or the pipe blank, for example, as described herein. In some embodiments, the orienting of the visual guide may include orienting the elongated strip of material, such that indicators spaced along a length of the elongated strip of material are substantially circumferentially aligned with the plurality of holes, for example, as described herein.

In some embodiments of the method for enhancing distribution of fastener force for connections associated with flanged pipes, the connecting of the visual guide to the one of the first flanged pipe, the second flanged pipe, or the pipe blank may include connecting, via one or more of magnetic attraction, adhesion, elastic tightening, or engagement between a first connector at a first end of the elongated strip of material and a second connector at a second end of the elongated strip of material, the visual guide to one or more of (a) a radially outward facing surface of the first flange, (b) a radially outward facing surface of the second flange, or (c) a radially outward facing surface of the pipe blank. For example, the connecting of the visual guide to the one or more of the radially outward facing surface of the first flange, the radially outward facing surface of the second flange, or the radially outward facing surface of the pipe blank may include connecting via the one or more of magnetic attraction or adhesive, for example, as described herein.

According to some embodiments of the method for enhancing distribution of fastener force for connections associated with flanged pipes, the indicators may include sequence markers indicative of the sequence for tightening the fasteners, for example, as described herein. The sequence markers may include one or more of a sequence of numbers or a sequence of letters, and the one or more of the sequence of numbers or the sequence of letters may be positioned along the length of the elongated strip of material, such that when the elongated strip of material is wrapped at least partially circumferentially around the one of the first flanged pipe, the second flanged pipe, or the pipe blank, the one or more of the sequence of numbers or the sequence of letters are arranged in a non-consecutive manner.

In some embodiments of the method for enhancing distribution of fastener force for connections associated with flanged pipes, the visual guide may include a sheet of material, and the connecting of the visual guide to one of the first flanged pipe, the second flanged pipe, or the pipe blank may include connecting the visual guide to one of an axial facing surface of the first flange of the first flanged pipe, an axial facing surface of the second flange of the second flanged pipe, or an axial facing surface of the pipe blank, for example, as described herein. For example, in some embodiments, the connecting of the visual guide to one of the first flanged pipe, the second flanged pipe, or the pipe blank may include connecting, via one or more of magnetic attraction or adhesive, the visual guide to the one of the axial facing surface of the first flange of the first flanged pipe, the axial facing surface of the second flange of the second flanged pipe, or the axial facing surface of the pipe blank, for example, as described herein. In at least some such embodiments, the indicators may include sequence markers indicative of the sequence for tightening the fasteners. The sequence markers may include one or more of a sequence of numbers or a sequence of letters, and the one or more of the sequence of numbers or the sequence of letters may be positioned around a circumference of the sheet of material, such that when the sheet of material is connected to the one of the first flange, the second flange, or the pipe blank, the one or more of the sequence of numbers or the sequence of letters are arranged in a non-consecutive manner, for example, as described herein. For example, the one or more of the sequence of numbers or the sequence of letters may be arranged, so that that one or more of: (a) consecutive numbers of the sequence of numbers or (b) consecutive letters of the sequence of letters, are substantially diametrically across from one another relative to the one of the first flange, the second flange, or the pipe blank. In some embodiments, the indicators further may include tightening torque markers. The tightening torque markers may be indicative of respective magnitudes of torque to which a corresponding fastener is to be tightened, and the method further may include tightening the corresponding fasteners according to the tightening torque markers, for example, as described herein.

According to some embodiments of the method for enhancing distribution of fastener force for connections associated with flanged pipes, the tightening of the fasteners may include tightening a first subset of the fasteners according to a first sequence and to a first tightening torque, and tightening thereafter a second subset of the fasteners according to a second sequence and to a second tightening torque, for example, as described herein. In at least some such embodiments, each of the first subset of the fasteners may differ from each of the second subset of the fasteners, and the first tightening torque may differ from the second tightening torque. In some embodiments, at least some of the first subset of the fasteners may be the same as at least some of the second subset of the fasteners. In some embodiments, the tightening of the fasteners further may include tightening a third subset of the fasteners according to a third sequence and a third tightening torque, and in some such embodiments, the tightening of the fasteners also may include tightening the fasteners according to a fourth sequence and a fourth tightening torque. In some embodiments, the tightening of the fasteners further may include tightening the fasteners according to a fifth sequence and a fifth tightening torque. In at least some embodiments, at least some of the second subset of the fasteners, at least some the third subset of the fasteners, and/or at least some of the fourth subset of fasteners may differ from one another, and the respective tightening torques may differ from one another. In some embodiments, at least some of the second subset of the fasteners, at least some the third subset of the fasteners, and/or at least some of the fourth subset of fasteners may be the same as one another. According to some embodiments, the indicators may be consistent with tightening the fasteners according to guidance of one or more of a regulatory body or a standard setting body, for example, as described herein.

In some embodiments, a method for enhancing connection of a first pipe and a second pipe to one another may include positioning a first flange of the first pipe adjacent a second flange of the second pipe, for example, as described herein. Positioning of the first flange adjacent to the second flange may include moving one or more of the first flange or the second flange toward one another. The first flange and/or the second flange may each include a plurality of holes for connecting the first pipe and the second pipe to one another (e.g., the first flange and the second flange). The method further may include wrapping a visual guide circumferentially around the first flange and/or the second flange, for example, as described herein. The visual guide may be consistent with any visual guides described herein, such as, for example, the example visual guides shown in FIGS. 1 and 3-9. For example, the visual guide may include an elongated strip of material, for example, as described herein. The method further may include orienting the visual guide relative to the first flange, such that indicators spaced along a length of the elongated strip of material are substantially circumferentially aligned with the plurality of holes of the first flange and/or the second flange, for example, as described herein. The method also may include associating fasteners with the plurality of holes, for example, inserting the fasteners into the holes, for example, as described herein. The method further may include tightening the fasteners according to the indicators spaced along the length of the elongated strip of material, for example, as described herein. In some embodiments, the indicators may include sequence markers indicative of a sequence for tightening the fasteners, thereby to enhance distribution of fastener force around the first flange, for example, as described herein.

In some embodiments of the method, the indicators further may include tightening torque markers, and the tightening torque markers may be indicative of respective magnitudes of torque to which a corresponding one of the plurality of fasteners is to be tightened. In at least some such embodiments, the method further may include tightening the corresponding fasteners according to the tightening torque markers, for example, as described herein.

In some embodiments of the method, the method further may include connecting, via magnetic attraction, adhesion, elastic tightening, and/or engagement between a first connector at a first end of the elongated strip of material and a second connector at a second end of the elongated strip of material, the visual guide to a radially outward facing surface of the first flange and/or a radially outward facing surface of the second flange. For example, in some embodiments, the method may include connecting the visual guide to a radially outward facing surface of the second flange via the one or more of magnetic attraction or adhesive, for example, as described herein.

In some embodiments of the method, the indicators may include sequence markers indicative of the sequence for tightening the fasteners, and the sequence markers may include a sequence of numbers and/or a sequence of letters, for example, as described herein. The sequence of numbers and/or the sequence of letters may be positioned along the length of the elongated strip of material, such that when the elongated strip of material is wrapped around the first flange and/or the second flange, the sequence of numbers and/or the sequence of letters are arranged in a non-consecutive manner, for example, as described herein. For example, the sequence of numbers and/or the sequence of letters may be positioned along the length of the elongated strip of material, such that when the elongated strip of material is wrapped around the first flange and/or the second flange, the sequence of numbers and/or the sequence of letters are arranged, so that that: (a) consecutive numbers of the sequence of numbers and/or (b) consecutive letters of the sequence of letters, are substantially diametrically across from one another relative to the first flange and/or the second flange.

In some embodiments of the method, tightening the fasteners may include tightening a first subset of the fasteners according to a first sequence and to a first tightening torque, and tightening thereafter a second subset of the fasteners according to a second sequence and to a second tightening torque, for example, as described herein. In at least some such embodiments, each of the first subset of the fasteners may differs from each of the second subset of the fasteners, and the first tightening torque may differ from the second tightening torque. In some embodiments of the method, tightening the fasteners further may include tightening a third subset of the fasteners according to a third sequence and a third tightening torque. In at least some such embodiments, tightening the fasteners further may include tightening the fasteners according to a fourth sequence and a fourth tightening torque, and/or tightening the fasteners further may include tightening the fasteners according to a fifth sequence and a fifth tightening torque. In some embodiments, the fasteners of different sets of fasteners may be unique to an associated set of fasteners, and in some embodiments, the fasteners of the different sets of fasteners may include fasteners that are also associated with one or more other sets of fasteners. In some embodiments of the method, the indicators may be consistent with tightening the fasteners according to guidance of one or more of: (a) a regulatory body or (b) a standard setting body, for example, as described herein.

In some embodiments, a method for enhancing distribution of fastener force for connections associated with flanged pipes, may include positioning a first flange of a first flanged pipe adjacent to one of a second flange of a second flanged pipe or a pipe blank positioned to cap the first flanged pipe. Positioning of the first flange adjacent to the second flange or the pipe blank may include moving one or more of the first flange, the second flange, or the pipe blank toward one another. The first flange and the one of the second flange of the second flanged pipe or the pipe blank may each include a plurality of holes for connecting the first flange of the first flanged pipe to the one of the second flange of the second flanged pipe or the pipe blank, for example, as described herein. The method further may include connecting a visual guide to one of the first flanged pipe, the second flanged pipe, or the pipe blank, for example, as described herein. The visual guide may be consistent with any visual guides described herein, such as, for example, the example visual guides shown in FIGS. 1 and 3-9. For example, the visual guide may include a sheet of material having indicators spaced around a periphery of the sheet of material. The indicators may be positioned to face axially outward when the sheet of material is connected to the one of the first flanged pipe, the second flanged pipe, or the pipe blank. The method also may include orienting the visual guide relative to the one of the first flanged pipe, the second flanged pipe, or the pipe blank, such that the indicators are substantially circumferentially aligned with the plurality of holes. The method further may include associating fasteners with the plurality of holes and tightening the fasteners according to the indicators on the visual guide, for example, as described herein. In some embodiments, the indicators may include sequence markers indicative of a sequence for tightening the fasteners, thereby to enhance distribution of fastener force around the first flange. According to some embodiments of the method, the indicators further may include tightening torque markers, the tightening torque markers being indicative of respective magnitudes of torque to which a corresponding fastener is to be tightened, for example, as described herein. In at least some such embodiments, the method further may include tightening the corresponding fasteners according to the tightening torque markers.

According to some embodiments of the method, the connecting of the visual guide to one of the first flanged pipe, the second flanged pipe, or the pipe blank may include connecting the visual guide to one of an axial facing surface of the first flange of the first flanged pipe, an axial facing surface of the second flange of the second flanged pipe, or an axial facing surface of the pipe blank, via one or more of magnetic attraction or adhesive, for example, as described herein.

In some embodiments of the method, the sequence markers may include one or more of a sequence of numbers or a sequence of letters, and the one or more of the sequence of numbers or the sequence of letters may be positioned around a circumference of the sheet of material, such that when the sheet of material is connected to one of the first flange, the second flange, or the pipe blank, the one or more of the sequence of numbers or the sequence of letters are arranged in a non-consecutive manner, for example, as described herein. For example, in some embodiments, the sequence of numbers or the sequence of letters may be positioned, such that when the sheet of material is connected to the one of the first flange, the second flange, or the pipe blank, the one or more of the sequence of numbers or the sequence of letters are arranged so that that one or more of: (a) consecutive numbers of the sequence of numbers or (b) consecutive letters of the sequence of letters, are substantially diametrically across from one another relative to the one of the first flange, the second flange, or the pipe blank.

According to some embodiments of the method, the tightening of the fasteners may include tightening a first subset of the fasteners according to a first sequence and to a first tightening torque, and tightening thereafter a second subset of the fasteners according to a second sequence and to a second tightening torque, for example, as described herein. Each of the first subset of the fasteners may differ from each of the second subset of the fasteners, and the first tightening torque may differ from the second tightening torque. The tightening of the fasteners further may include tightening a third subset of the fasteners according to a third sequence and a third tightening torque, and in some embodiments, tightening the fasteners according to a fourth sequence and a fourth tightening torque, and in still other embodiments, tightening the fasteners according to a fifth sequence and a fifth tightening torque, for example, as described herein.

Having now described some illustrative embodiments of the disclosure, it should be apparent to those skilled in the art that the foregoing is merely illustrative and not limiting, having been presented by way of example only. Numerous modifications and other embodiments are within the scope of one of ordinary skill in the art and are contemplated as falling within the scope of the disclosure. In particular, although many of the examples presented herein involve specific combinations of method acts or system elements, it should be understood that those acts and those elements may be combined in other ways to accomplish the same objectives. Those skilled in the art should appreciate that the parameters and configurations described herein are exemplary, and that actual parameters and/or configurations will depend on the specific application in which the systems, methods, and/or aspects or techniques of the disclosure are used. Those skilled in the art should also recognize or be able to ascertain, using no more than routine experimentation, equivalents to the specific embodiments of the disclosure. It is, therefore, to be understood that the embodiments described herein are presented by way of example only and that, within the scope of any appended claims and equivalents thereto, the disclosure may be practiced other than as specifically described.

Furthermore, the scope of the present disclosure shall be construed to cover various modifications, combinations, additions, alterations, etc., above and to the above-described embodiments, which shall be considered to be within the scope of this disclosure. Accordingly, various features and characteristics as discussed herein may be selectively interchanged and applied to other illustrated and non-illustrated embodiments, and numerous variations, modifications, and additions further may be made thereto without departing from the spirit and scope of the present disclosure as set forth in the appended claims.

1. A visual guide to enhance distribution of fastener force for connections associated with flanged pipes, the visual guide comprising:
an overlay including indicators spaced from one another, the indicators being positioned to face outward when the overlay is connected to an outward facing surface of a first flanged pipe, the indicators including sequence markers indicative of:
(a) circumferential fastener locations corresponding to fasteners for securing the first flange of the first flanged pipe to one of:
(i) a second flange of a second flanged pipe; or
(ii) a pipe blank positioned to cap the first flanged pipe; and
(b) a tightening sequence indicative of an order for tightening the fasteners, the indicators being positioned to provide a guide for the tightening sequence, thereby to enhance the distribution of fastener force around the first flange for the fasteners securing the first flanged pipe and the one of the second flange or the pipe blank.

2. The visual guide of claim 1, wherein the overlay includes (a) an elongated strip of material, the elongated strip of material being flexible, thereby to be wrapped around a radially outward facing surface of the first flanged pipe or (b) a sheet of material at least partially defining a hole, and the indicators are positioned to face axially outward when the sheet of material is connected to a first flange of a first flanged pipe.

3. The visual guide of claim 1, wherein the indicators are spaced about the overlay, the indicators being positioned to face outward when the overlay is connected to the first flanged pipe.

4. The visual guide of claim 1, wherein the indicators include sequence markers indicative of (a) circumferential fastener locations corresponding to fasteners for securing a first flange of the first flanged pipe to a second flange of a second flanged pipe and (b) a tightening sequence indicative of an order for tightening the fasteners, the indicators being positioned to provide a guide for the tightening sequence, thereby to enhance the distribution of fastener force around the first flange for the fasteners securing the first flanged pipe and the second flanged pipe to one another.

5. The visual guide of claim 1, wherein the indicators further comprise tightening torque markers associated with at least some of the sequence markers, the tightening torque markers being indicative of a respective magnitude of tightening torque to which a corresponding one of the fasteners is to be tightened.

6. The visual guide of claim 5, wherein the tightening torque markers comprise:
a first set of tightening torque markers indicative of a respective first magnitude of tightening torque to which a first set of corresponding fasteners is to be tightened; and
a second set of tightening torque markers indicative of a respective second magnitude of tightening torque to which a second set of corresponding fasteners is to be tightened,
the respective second magnitude of tightening torque to which the second set of corresponding fasteners is to be tightened being greater than the respective first magnitude of tightening torque to which the first set of corresponding fasteners is to be tightened.

7. The visual guide of claim 6, wherein the tightening torque markers comprise a third set of tightening torque markers indicative of a respective third magnitude of tightening torque to which a third set of corresponding fasteners is to be tightened, the respective third magnitude of tightening torque to which the third set of corresponding fasteners is to be tightened being greater than one or more of: (a) the respective first magnitude of tightening torque to which the first set of corresponding fasteners is to be tightened, or (b) the respective second magnitude of tightening torque to which the second set of corresponding fasteners is to be tightened.

8. The visual guide of claim 1, wherein the sequence markers comprise one or more of a sequence of numbers or a sequence of letters, the one or more of the sequence of numbers or the sequence of letters being positioned along a length of the overlay, such that when the overlay is wrapped around one or more of the first flange or the second flange, the one or more of the sequence of numbers or the sequence of letters are arranged in a non-consecutive manner.

9. The visual guide of claim 8, wherein the one or more of the sequence of numbers or the sequence of letters are positioned along the length of the overlay, such that when the overlay is wrapped around the one or more of the first flange or the second flange, the one or more of the sequence of numbers or the sequence of letters are arranged, so that one or more of: (a) consecutive numbers of the sequence of numbers or (b) consecutive letters of the sequence of letters, are substantially diametrically across from one another relative to the one or more of the first or the second flange.

10. The visual guide of claim 1, wherein the overlay comprises one or more of a polymeric material, a magnetic material, an adhesive material, or an elastic material configured to connect the overlay to one or more of the first flange of the first flanged pipe or the second flange of the second flanged pipe.

11. The visual guide of claim 10, wherein the overlay includes an elongated strip of material including one of (a) a strip of magnetic material or (b) a plurality of sections of magnetic material spaced along a length of the elongated strip of material.

12. The visual guide of claim 11, wherein the overlay comprises a polymeric material connected to the one of the strip of magnetic material or the plurality of sections of magnetic material.

13. The visual guide of claim 12, wherein the indicators include visual indicators and are one a side of the overlay opposite the one of the strip of magnetic material or the plurality of sections of magnetic material.

14-15. (canceled)

16. The visual guide of claim 15, wherein each of the plurality of tags includes a tag sequence marker corresponding to an adjacent sequence marker associated with the overlay, the tag sequence markers being indicative of: (a) circumferential fastener locations corresponding to fasteners for securing the first flange of the first flanged pipe to the second flange of the second flanged pipe and (b) a tightening sequence indicative of an order for tightening the fasteners associated with the tag sequence markers.

17-22. (canceled)

23. The visual guide of claim 1, wherein the indicators are consistent with tightening the fasteners according to guidance of one or more of: (a) a regulatory body or (b) a standard setting body.

24-57. (canceled)

58. A visual guide set to enhance distribution of fastener force for connections associated with flanged pipes having one or more of different sizes or different pressure ratings, the visual guide set comprising a plurality of different visual guides comprising:
(a) a first visual guide of the plurality of visual guides, the first visual guide comprising a first overlay comprising first indicators spaced apart from one another, the first indicators being positioned to face outward when the first overlay is connected to one or more of:
(i) a first flanged pipe, or
(ii) a second flanged pipe,
the first flanged pipe and the second flanged pipe each having a first size and a first pressure rating; and
(b) a second visual guide of the plurality of visual guides, the second visual guide comprising a second overlay comprising second indicators spaced apart from one another, the second indicators being positioned to face outward when the second overlay is connected to one or more of:
(i) a third flanged pipe, or
(ii) a fourth flanged pipe,
the third flanged pipe and the fourth flanged pipe each having a second size and a second pressure rating.

59. The visual guide set of claim 58, wherein one or more of: (i) the first size is different than the second size, or (ii) the first pressure rating is different than the second pressure rating.

60. The visual guide set of claims 58, further comprising:
(a) a third visual guide of the plurality of visual guides, the third visual guide comprising a third overlay comprising third indicators spaced apart from one another, the third indicators being positioned to face outward when the third overlay is connected to one or more of:
(i) a fifth flanged pipe, or
(ii) a sixth flanged pipe, the fifth flanged pipe and the sixth flanged pipe each having a third size and a third pressure rating; and
(b) one or more of:
(i) the third size is different than the first size and the second size, or
(ii) the third pressure rating is different than the first pressure rating and the second pressure rating.

61. The visual guide set of claim 58, wherein one or more of:
the first indicators further comprise first tightening torque markers associated with at least some of the first sequence markers, the first tightening torque markers being indicative of a respective first magnitude of tightening torque to which a corresponding one of a plurality of first fasteners is to be tightened to connect the first flanged pipe and the second flanged pipe to one another; or
the second indicators further comprise second tightening torque markers associated with at least some of the second sequence markers, the second tightening torque markers being indicative of a respective second magnitude of tightening torque to which a corresponding one of a plurality of second fasteners is to be tightened to connect the third flanged pipe and the fourth flanged pipe to one another,
the respective first magnitude of tightening torque being different than the respective second magnitude of tightening torque.

62. (canceled)

63. A method for enhancing distribution of fastener force for connections associated with flanged pipes, the method comprising:
positioning a first flange of a first flanged pipe adjacent to one of: (i) a second flange of a second flanged pipe or (ii) a pipe blank positioned to cap the first flanged pipe, the first flange and the one of the second flange of the second flanged pipe or the pipe blank including a plurality of holes for connecting the first flange of the first flanged pipe to the one of the second flange of the second flanged pipe or the pipe blank;
connecting a visual guide to one of the first flanged pipe, the second flanged pipe, or the pipe blank;
orienting the visual guide relative to the one of the first flanged pipe, the second flanged pipe, or the pipe blank, such that indicators spaced from one another on the visual guide are substantially circumferentially aligned with the plurality of holes;
associating fasteners with the plurality of holes; and
tightening the fasteners according to the indicators on the visual guide, the indicators including sequence markers indicative of a sequence for tightening the fasteners, thereby to enhance distribution of fastener force around the first flange.

64-101. (canceled)
